(19) United States
(12) Patent Application Publication
(10) Pub. No.: US 2008/0138616 A1
(43) Pub. Date: Jun. 12, 2008

(54) Heat absorbing textile

(76) Inventor: Chi-Cheng Fang, Taipei (TW)

Correspondence Address: COOPER & DUNHAM, LLP, 1185 AVENUE OF THE AMERICAS, NEW YORK, NY, 10036, US

(21) Appl. No.: 11/636,080

(22) Filed: Dec. 8, 2006

(51) Int. Cl. B32B 7/12

(52) U.S. Cl. 428/343

(57) ABSTRACT

A textile made of cotton and includes an adhesive applied to a side of the textile and having therein a mineral capable of emitting far infrared rays.

### BACKGROUND OF THE INVENTION

1. Field of the Invention

The present invention relates to a heat absorbing textile, and more particularly to a textile having a layer of adhesive applied to a side of the textile and provided with a kind of mines capable of emitting far infrared rays and crystal powder mixed inside the adhesive.

2. Description of the Prior Art

The general purpose of clothing is to keep the user warm and because the material used to make the clothing is so different that capability of keeping warm existed among clothing of different materials varies. The most common materials for making clothing are cotton, hemp and artificial fibers, among which the clothing made of cotton has the best capability to keep warm.

Even the clothing made of cotton has the best capability of keeping warm and has great gas permeability, the clothing becomes heavy and bulky if the clothing is to be used in extreme cold temperature so as to keep the user warm, which discomforts the user for the loss of maneuverability. To cope with the problem, a textile which is lightweight and has great capability in keeping warm becomes a task to the industry.

To overcome the shortcomings, the present invention tends to provide an improved heat absorbing textile to mitigate the aforementioned problems.

### SUMMARY OF THE INVENTION

The primary objective of the present invention is to provide a heat absorbing textile having a layer of adhesive applied to a side of the textile and having therein powder of a mine capable of emitting far infrared rays and crystal powder so that body temperature from the user is absorbed by the mine powder to accomplish the purpose of lightweight and having great warm keeping capability.

Other objects, advantages and novel features of the invention will become more apparent from the following detailed description when taken in conjunction with the accompanying drawings.

### BRIEF DESCRIPTION OF THE DRAWINGS

FIG. 1 is a cross sectional view of the textile of the present invention.

### DETAILED DESCRIPTION OF THE PREFERRED EMBODIMENT

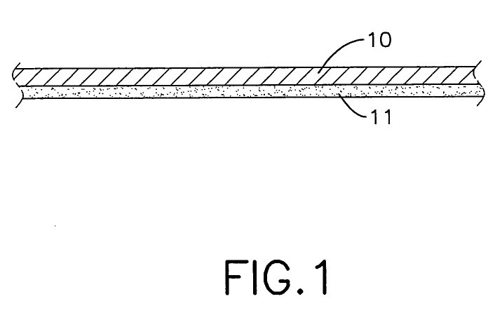

With reference to FIG. 1, it is noted that the textile (10) made in accordance with the present invention has a layer of adhesive (11) applied to a side of the textile (10). The layer of adhesive (11) is composed of a first powder from a mine capable of emitting far infrared rays such as granite, dolomite or silicone stone. Each of the mines contains aluminum oxide, magnesium oxide and silicone oxide. Each of the elements is mixed with appropriate proportion and then grounded into powder. The mixed powder is added in an adhesive to allow the adhesive (11) of the present invention to have the powder capable of emitting far infrared rays. As well known in the art, the far infrared rays is able to absorb heat from the user. In addition, the adhesive (11) applied to the side of the textile (10) is able to prevent heat loss.

The textile (10) of the present invention is able to make different products such as sleeping bags, thermo bags, mattresses, shoe sole, diving suits, snow clothing, vests, racing clothing, fishing clothing, combat clothing, or bags for keeping foods. Clothing made of the textile (10) of the present invention is suitable for countries with low temperatures so that workers are able to work with lightweight clothing in extreme temperatures.

Because there is only a layer of adhesive coated on a side of the textile, the clothing is lightweight and has better temperature maintaining capability than other textiles. In average, the temperature inside the clothing made of the textile (10) of the present invention is 5 degrees more than that of the clothing made of other textiles. Further, to increase the wearer's health, a magnetic powder is added into the adhesive (11) of the present invention to increase blood circulation.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. A heat absorbing textile having:
a layer of adhesive applied to a side of the textile and having therein crystal powder of a mineral capable of emitting far infrared rays.

2. (canceled)

3. (canceled)
